(19) United States
(12) Patent Application Publication
(10) Pub. No.: US 2025/0016718 A1
(43) Pub. Date: Jan. 9, 2025

(54) UWB-BASED DUAL-BASE STATION POSITIONING TAG METHOD AND SYSTEM

(71) Applicant: SHENZHEN PATPET TECHNOLOGY CO., LTD., Shenzhen (CN)

(72) Inventors: Yunhe DING, Shenzhen (CN); Xinming HUO, Shenzhen (CN); Linxian LI, Shenzhen (CN); Yawei XU, Shenzhen (CN)

(73) Assignee: SHENZHEN PATPET TECHNOLOGY CO., LTD., Shenzhen (CN)

(21) Appl. No.: 18/448,365

(22) Filed: Aug. 11, 2023

(30) Foreign Application Priority Data
Jul. 7, 2023 (CN) 202310828177.X

(51) Int. Cl. H04W 64/00

(52) U.S. Cl. CPC H04W 64/00

(57) ABSTRACT

A UWB-based dual-base station positioning tag method includes the following steps: carrying out a first time difference collection through a TOF scheme between a master base station and a slave base station after two stations complete the Bluetooth connection, and calculating a distance and an angle between two stations by adopting a UWB scheme; after a second time difference is collected through the TOF scheme between a tag and the master base station, calculating to obtain a distance R1 between the tag and the master base station, an angle θ1 between the tag and the master base station; and after a third time difference is collected through the TOF scheme between the tag and the slave base station, calculating to obtain a distance R2 between the tag and the slave base station, an angle θ2 between the tag and the slave base station.

### CROSS-REFERENCE TO RELATED APPLICATIONS

This application claims priority to Chinese Patent Application No. 202310828177.X, filed on Jul. 7, 2023, the content of which is incorporated herein by reference in its entirety.

### TECHNICAL FIELD

The present disclosure generally relates to Ultra-wideband (UWB) positioning, in particular to a UWB-based dual-base station positioning tag method and system.

### BACKGROUND

UWB technology is a wireless carrier communication technology. UWB does not use a sinusoidal carrier, but transmits data by using a non-sinusoidal narrow pulse of a nanosecond level, so the occupied frequency spectrum is wide. The UWB technology has the advantages of low system complexity, low emission signal power spectrum density, insensitive channel fading, low interception capability, high positioning accuracy and the like, and is especially suitable for high-speed wireless access of dense multipath occasions such as indoors. The disadvantages of the existing UWB positioning scheme are: 1, the current precise positioning scheme adopts three or more base stations to realize tag positioning, the base station is expensive, the positioning cost is high; 2, the angle offset of the positioning direction of the single base station is serious, and the phenomenon of poor positioning accuracy exists.

Therefore, the above defects existing in the existing UWB positioning solution are technical problems to be solved.

### SUMMARY

According to some embodiments of the present disclosure, a UWB-based dual-base station positioning tag method and system is provided.

One aspect of the present disclosure relates to a UWB-based dual-base station positioning tag method, which is applied to a UWB-based positioning device, the UWB-based positioning device comprises a master base station, a slave base station, and a tag, a master base station, a slave base station and the tag establish a communication connection, and the UWB-based dual-base station positioning tag method includes following steps.

After the master base station is powered on, the master base station broadcasts its own information to realize signal transmission and reception.

After the master base station and the slave base station complete the Bluetooth connection, the master base station and the slave base station perform a first time difference collection through a TOF scheme, and calculate a distance and angle between the master base station and the slave base station by using the UWB scheme.

After the tag is turned on, the tag is changed to a discoverable state, the master base station establishes a connection with the tag after searching the tag, and the tag sends its own MAC address to the master base station; the master base station performs data encryption on the MAC address of the tag, transmits the encrypted data to the tag and the slave base station, and implements communication connection between the master base station and the slave base station and the tag by using the encrypted MAC ID as a communication basis.

After a second time difference is collected between the tag and the master base station through the TOF scheme, the distance and angle between the tag and the master base station are calculated by using the UWB scheme, and a distance R₁ between the tag and the master base station and an angle θ₁ between the tag and the master base station are calculated.

After a third time difference collection is performed between the tag and the slave base station through the TOF scheme, the distance and angle calculation between the tag and the master base station are performed by using the UWB scheme, to calculate a distance R₂ between the tag and the slave base station, and an angle θ₂ between the tag and the slave base station.

Defining a center point of the master base station and the slave base station as an origin, calculating a possible position of the tag as a position point A or a position point B according to the distance R₁ between the tag and the master base station, and the distance R₂ between the tag and the slave base station.

The position point A and the position point B are respectively judged through a preset a first angle threshold and a second angle threshold, the error point is discarded, and the correct point is reserved; and the reserved right point is the position of the label at the current time, and the positioning of the master base station and the secondary base station from the base station is completed.

Further, after the second time difference is collected between the tag and the master base station through the TOF scheme, the distance and angle between the tag and the master base station are calculated by using the UWB scheme, and in the step of calculating the distance R₁ between the tag and the master base station, the angle θ₁ between the tag and the master base station, the distance R₁ between the tag and the master base station is calculated by using the TOF scheme, and the angle θ₁ between the tag and the master base station is calculated through the AOD angle.

Further, the angle θ₁ between the tag and the master base station is calculated according to the following formula:

$${θ}_{1} = ar cos ( ( {ψ}_{1} λ ) / ( 2 π {d}_{1} ) )$$

Where θ₁ is the angle between the tag and the master base station, ψ₁ is the difference between the signal phase of a first UWB antenna on the master base station and the signal phase of a second UWB antenna on the master base station, λ is the signal wavelength, d₁ is the antenna spacing between the first UWB antenna on the master base station and the second UWB antenna on the master base station, and π is the circular rate.

Further, after the third time difference collection is performed between the tag and the slave base station through the TOF scheme, the distance and angle calculation between the tag and the master base station are performed by using the UWB scheme, the distance R₂ between the tag and the slave base station is calculated, the distance R₂ between the tag and the slave base station is calculated through the TOF scheme, and the angle θ₂ between the tag and the slave base station is calculated through the AOD angle.

Further, it is defined that the step of calculating the possible position of the tag as the position point A or the position point B according to the distance R₁ between the tag and the master base station and the distance R₂ between the tag and the slave base station is defined as:

Taking the distance R₁ between the master base station as the circle center and the label and the master base station as a radius circle.

A circle is drawn from the base station as a circle center, and a distance R₂ between the label and the slave base station is a radius.

The position pointA is defined above the intersection point of two circles, and the position point B is below the intersection point; the master base station is set to be a zero point, the direction of the base station is the positive direction of the X axis and the positive direction of the Y axis is above the master and slave base station, the coordinates of the position point A and the position point B are ((R₃²+R₁²−R₂²)/2/R₃, ±((R₁²+R₂²)/2−R₃²/4−(R₁²−R₂²)²/4/R₃²)¹/2), and if (θ₁+θ₂)<180°, the calculated point is the position point A ((R₃²+R₁²−R₂²)/2/R₃, ((R₁²+R₂²)/2−R₃²/4−(R₁²−R₂²)²/4/R₃²)¹/2); if (θ₁+θ₂)>180° the calculated point is the position point B ((R₃²+R₁²−R₂²)/2/R₃, −((R₁²+R₂²)/2−R₃²/4−(R₁²−R₂²)²/4/R₃²)¹/2), wherein R₁ is the distance between the main base station and the tag, R₂ is the distance between the slave base station and the tag, R₃ is the distance between the master base station and the slave base station; θ₁ is the angle between the master base station and the tag, and θ₂ is the angle between the slave base station and the tag.

Another aspect of the present disclosure relates to a UWB-based dual-base station positioning tag system, which is applied to a UWB-based positioning device, the UWB-based positioning device includes a master base station, a slave base station, and a tag, the master base station, the slave base station and the tag establish a communication connection, and the UWB-based dual-base station positioning tag system includes:
a first communication connection module, configured to broadcast its own information after the master base station is powered on to realize signal transmission and reception;
a first calculation module is configured to perform a first time difference collection between the master base station and the slave base station through a TOF scheme after the master base station and the slave base station complete the Bluetooth connection, and calculate a distance and an angle between the master base station and the slave base station by using a UWB scheme.
a second communication connection module, configured to, after the tag is turned on, change itself to a discoverable state, establish a connection with the tag after the master base station searches the tag, and send the MAC address of the tag to the master base station; the master base station performs data encryption on the MAC address of the tag, and transmits the encrypted data to the tag and the slave base station, and the encrypted MAC ID is used as a communication basis to implement communication connection between the master base station and the slave base station and the tag;
a second calculation module, configured to calculate the distance and angle between the tag and the master base station by using the UWB scheme after a second time difference is collected by using the TOF scheme between the tag and the master base station, and calculate a distance R₁ between the tag and the master base station, and an angle θ₁ between the tag and the master base station;
a third calculation module, configured to perform distance and angle calculation between the tag and the slave base station by using the UWB scheme after a third time difference is collected by using the TOF scheme, to calculate a distance R₂ between the tag and the slave base station, and an angle θ₂ between the tag and the slave base station;
a fourth calculation module, configured to define that the center point of the master base station and the slave base station is the origin, and calculate, according to the distance R₁ between the tag and the master base station, and the distance R₂ between the tag and the slave base station, that the possible position of the tag is a position point A or a position point B;
a positioning module, configured to determine the position point A and the position point B respectively according to a preset first angle threshold and a second angle threshold, discard the error point, and reserve a correct point; and if the reserved right point is the position of the label at the current time, complete the positioning of the master base station and the slave base station dual-base station.

Further, in the second calculation module, the distance R₁ between the tag and the master base station is calculated by using the TOF scheme, and the angle θ₁ between the tag and the master base station is calculated through the AOD angle.

Further, the angle θ₁ between the tag and the master base station is calculated according to the following formula:

$${θ}_{1} = ar cos ( ( {ψ}_{1} λ ) / ( 2 π {d}_{1} ) )$$

Where θ₁ is the angle between the tag and the master base station, ψ₁ is the difference between the signal phase of the first UWB antenna on the master base station and the signal phase of the second UWB antenna on the master base station, λ is the signal wavelength, d₁ is the antenna spacing between the first UWB antenna on the master base station and the second UWB antenna on the master base station, and π is the circular rate.

Further, in the third calculation module, the distance R₂ between the tag and the slave base station is calculated by using the TOF scheme, and the angle θ₂ between the tag and the slave base station is calculated through the AOD angle.

Further, the fourth calculation module includes:
a first drawing unit, configured to circle a circle with a distance R₁ between the master base station as a circle center and a distance R₁ between the tag and the master base station;
a second drawing unit, configured to circle a circle with a distance R₂ from the base station as a circle center and a distance R₂ between the label and the slave base station;
a calculation unit, configured to define a position point A above an intersection point of two circles, and a position point B below an intersection point; set a main base station as a zero point, and from a base station direction to a positive direction of the X axis and a positive direction of a Y axis above the master/slave base station, coordinates of the position point A and the position point B are ((R₃²+R₁²−R₂²)/2/R₃, ±((R₁²+R₂²)/2−R₃²/4−(R₁²−R₂²)²/4/R₃²)¹/2, and if (θ₁+θ₂)<180°, the calculated point is a position point A ((R₃²+R₁²−R₂²)/2/R₃, ((R₁²+R₂²)/2−R₃²/4−(R₁²−R₂²)²/4/R₃²)¹/2); if (θ₁+θ₂)>180°, the calculated point is a position point B ((R₃²+R₁²−R₂²)/2/R₃, −((R₁²+R₂²)/2−R₃²/4−(R₁²−R₂²)²/4/R₃²)¹/2), where R₁ is the distance between the main base station and the tag, R₂ is the distance between the slave base station and the tag, R₃ is the distance between the master base station and the slave base station; θ₁ is the angle between the master base station and the tag, and θ₂ is the angle between the slave base station and the tag.

The beneficial effects obtained by the present disclosure are as follows.

A UWB-based positioning tag positioning method and system for a dual-base station, which is applied to UWB-based positioning equipment, and broadcasts self information after being started through a master base station to realize signal transmission and reception; after the master base station and a slave base station complete Bluetooth connection, a master base station and a slave base station perform first time difference collection through a TOF scheme, and a UWB scheme is used for calculating the distance and the angle between the master base station and the slave base station; after the tag is started, the tag is changed to a discoverable state, the master base station establishes a connection with the tag after searching the tag, and the tag sends the MAC address of the master base station to the master base station; after the master base station performs second time difference collection through the TOF scheme, the distance and the angle between the tag and the master base station are calculated by adopting the UWB scheme, and the distance R₁ between the tag and the master base station and the angle θ₁ between the tag and the master base station are calculated; after the third time difference is collected through the TOF scheme between the tag and the slave base station, the distance and the angle calculation of the tag and the master base station are calculated by adopting the UWB scheme, the distance R₂ between the tag and the slave base station is calculated, and the angle θ₁ between the tag and the slave base station is calculated; the center point of the master base station and the slave base station is defined as the origin, the distance R₁ between the tag and the master base station, and the distance R₂ between the tag and the slave base station are calculated, and the possible position of the tag is calculated to be the position point A or the position point B; the position point A and the position point B are judged according to the preset first angle threshold and the second angle threshold, the error point is abandoned, and the correct point is reserved; and the reserved right point is the position of the tag at the current time, and the positioning of the master base station and the slave base station dual-base station is completed. According to the UWB-based dual-base station positioning tag positioning method and system, accurate positioning is achieved through the dual-base station, base station information communication connection and communication group establishment are carried out through Bluetooth, compared with three or more base stations, positioning and lowering cost is reduced, and compared with a single base station positioning, positioning precision is improved.

### BRIEF DESCRIPTION OF THE DRAWINGS

FIG. 1 is a schematic flowchart of a UWB-based dual-base station positioning tag method.

FIG. 2 is a functional block diagram of a UWB-based positioning device.

FIG. 3 is a schematic flowchart of the step of calculating the possible position of a tag as a position point A or a position point B, according to a distance R₁ between the tag and a master base station and a distance R₂ between the tag and a slave base station as shown in FIG. 1.

FIG. 4 is a schematic diagram of implementation and optimization of TOF.

FIG. 5 is a schematic diagram of an AOD angle calculation principle.

FIG. 6 is a schematic diagram of calculating a distance from a tag by a master base station and a slave base station.

FIG. 7 is a functional block diagram of a UWB-based dual-base station positioning tag system.

FIG. 8 is a schematic diagram of functional modules of the positioning module shown in FIG. 7.

### DETAILED DESCRIPTION OF THE EMBODIMENTS

The foregoing technical solutions are described in detail with reference to the accompanying drawings and specific embodiments.

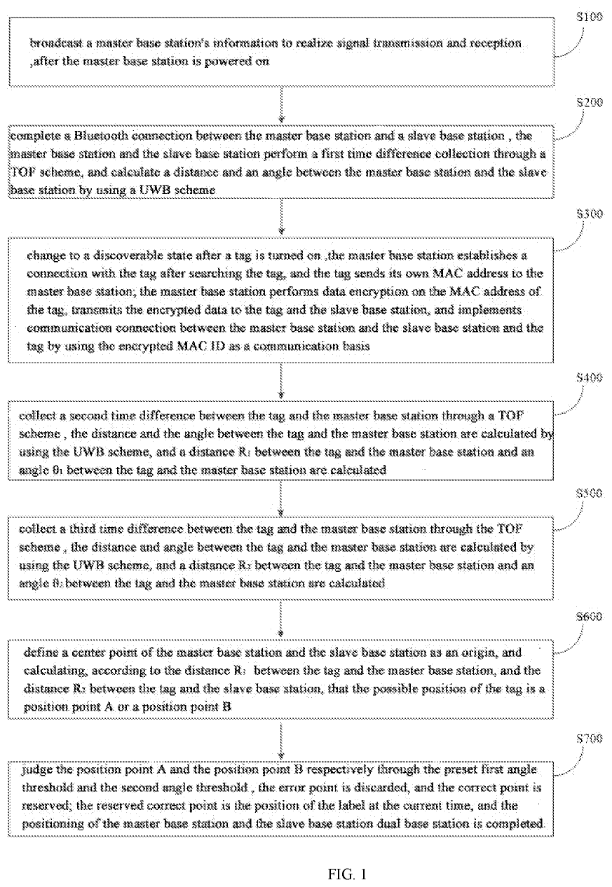

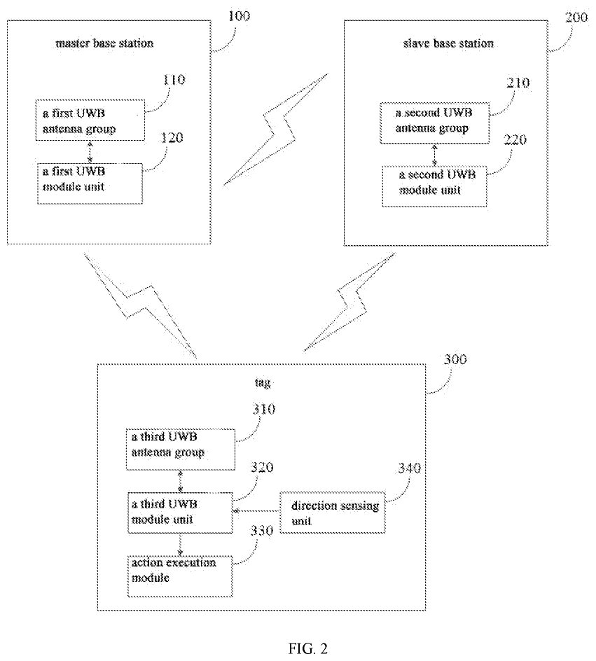

As shown in FIG. 1 and FIG. 2, an aspect of the present disclosure provides a UWB-based positioning tag positioning method for a dual-base station, applied to a UWB-based positioning device, the UWB-based positioning device includes a master base station 100, a slave base station 200, and a tag 300, a master base station 100, a slave base station 200 and a tag 300 establish a communication connection, the master base station unit 100 includes a first UWB module unit 110 and a first UWB antenna group 120 connected to the first UWB module unit 110, the slave base station 200 includes a second UWB module unit 210 and a second UWB antenna group 220 connected to the second UWB module unit 210, and the tag 300 includes a third UWB module unit 310 and a third UWB antenna group 320, a direction sensing unit 330, and an action execution module 340 connected to the third UWB module unit 310, respectively. In this embodiment, the tag 300 is used as a positioning point to assist positioning, and precise positioning is achieved by taking a house of the positioning point. The master base station unit 100, the slave base station 200, and the tag 300 may establish a Bluetooth communication connection, or may establish another communication connection, both within the protection scope of this patent. In the UWB-based positioning system provided in this embodiment, the first UWB antenna group 120 includes a first Bluetooth chip and a first Bluetooth antenna connected to the first Bluetooth chip. The second UWB antenna group 220 includes a second Bluetooth chip and a second Bluetooth antenna connected to the second Bluetooth chip. The third UWB antenna group 320 includes a third Bluetooth chip and a third Bluetooth antenna connected to the third Bluetooth chip.

In this embodiment, the UWB-based dual-base station positioning tag includes the following steps:

In step S100, after the master base station is powered on, the master base station broadcasts its own information to realize signal transmission and reception.

Through the flash memory and the chip pre-storage software, the PCBA power supply is carried out through the adapter or the built-in battery, the main base station broadcasts self information through the Bluetooth chip arranged in the main base station after being started, and signal transmission and reception are realized through the Bluetooth antenna arranged in the Bluetooth chip.

In step S200, after the master base station and the slave base station complete the Bluetooth connection, the master base station performs first time difference collection with the slave base station through a TOF scheme, and uses the UWB scheme to calculate the distance and angle between the master base station and the slave base station.

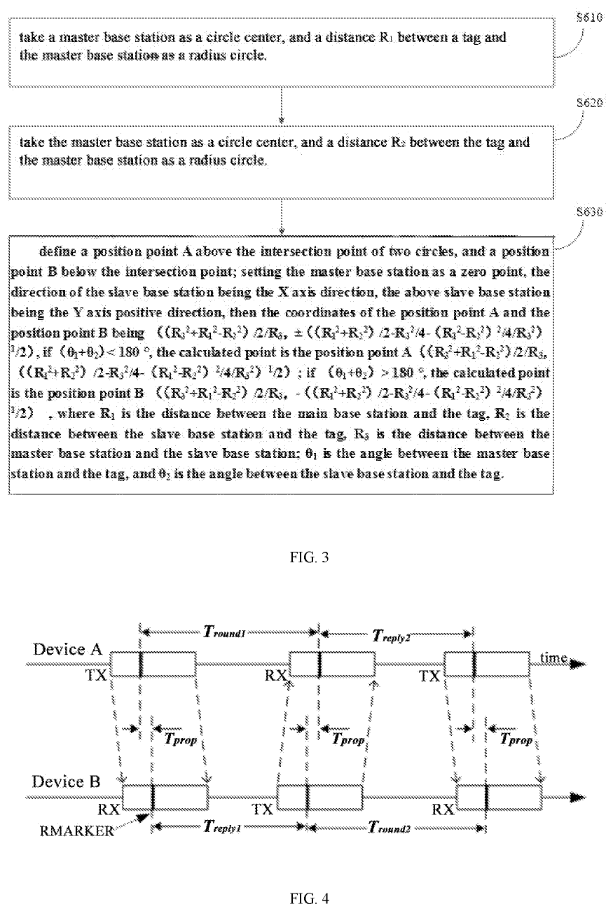

After the master base station and the slave base station complete the Bluetooth connection, the packet definition of the software layer is realized through the flash pre-stored software, the PCBA release signal is controlled through the UWB chip, signal transmission and reception are carried out through the UWB antenna, time difference collection is carried out through the TOF scheme (TOF-TWR), the DS-TWR ranging principle is as shown in FIG. 4), the distance and angle calculation (distance calculation through the TOF scheme) of the master base station and the slave base station are carried out through the UWB chip, the angle calculation is calculated through the AOD (departure angle method), the AOD calculation principle is shown in FIG. 5 and description), and the information is recorded and retained through the chip and the flash memory.

Please refer to FIG. 4, DeviceA and DeviveB are the master base station and the slave base station. TX is transmit data and RX is receive data. The distance between the master base station and the slave base station is obtained by using the TOF distance measurement formula:

$${T}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )} \qquad ( 1 )$$

In formula (1), Tₚᵣₒₚ is the signal flight time, T_{round1} is the first communication cycle time, T_{reply1} is the first signal reply time, T_{round2} is the second communication cycle time, T_{reply2} is the second signal reply time, two round trip time measurements are used, and the two round trip time measurements are combined to obtain a time of flight result, and finally multiplied by the speed of light to obtain the real-time distance between the devices, which is Tₚᵣₒₚ*299792458 meters.

In step S300, after the tag is turned on, the tag is changed to a discoverable state, the master base station establishes a connection with the tag after searching for the tag, and the tag sends the MAC address of the tag to the master base station; the master base station performs data encryption on the MAC address of the tag, transmits the encrypted data to the tag and the slave base station, and implements communication connection between the master base station and the slave base station and the tag by using the encrypted MAC ID as a communication basis.

The tag (actually positioned equipment, freely movable) supplies power to the PCBA through the built-in battery, and after being started, the label is changed into a discoverable state through the Bluetooth chip, after the master base station searches for the label, the label is connected with the master base station through the Bluetooth chip, and the label sends the MAC address of the label to the master base station. The master base station performs data encryption on the MAC address of the tag through the built-in function of the UWB chip, transmits data to and from the tag through the UWB chip, and uses the encrypted MAC ID (Media Access Control Identifier) as a communication basis to realize communication between the master base station and the slave base station and the tag.

In step S400, after the second time difference is collected between the tag and the master base station, the distance and angle between the tag and the master base station are calculated by using the UWB scheme, and the distance R₁ between the tag and the master base station and the angle θ₁ between the tag and the master base station are calculated.

The tag controls the PCBA release signal through the UWB chip, performs signal transmission and reception through the UWB antenna, and performs time difference collection through the TOF scheme. After the time difference between the tag and the master base station through the TOF scheme is collected, the distance and angle calculation of the tag and the master base station are carried out through the UWB chip, and the distance is calculated as R₁ and the angle is θ₁.

As shown in FIG. 5, assuming that the antenna array of the primary base station includes two antennas and the antenna spacing is d₁, and the label uses one antenna to receive the signal, the calculation formula of the difference ψ₁ between the signal phase from the first UWB antenna and the signal phase from the second UWB antenna on the master base station is as follows:

$${Ψ}_{1} = ( 2 π {d}_{1} cos ( {θ}_{1} ) ) / λ \qquad ( 2 )$$

In formula (2), ψ₁ is the difference between the signal phase of the first UWB antenna from the master base station and the signal phase of the second UWB antenna on the master base station, λ is the signal wavelength, θ₁ is the angle between the tag and the master base station, d₁ is the antenna spacing between the first UWB antenna on the master base station and the second UWB antenna on the master base station, and π is the circular rate.

The angle θ₁ between the tag and the master base station is calculated by the following formula:

$${θ}_{1} = ar cos ( ( {ψ}_{1} λ ) / ( 2 π {d}_{1} ) ) \qquad ( 3 )$$

In formula (3), θ₁ is the angle between the tag and the master base station, ψ₁ is the difference between the signal phase of the first UWB antenna from the master base station and the signal phase of the second UWB antenna on the master base station, λ is the signal wavelength, d₁ is the antenna spacing between the first UWB antenna on the master base station and the second UWB antenna on the master base station, and π is the circular rate.

In step S500, after the third time difference collection is performed between the tag and the slave base station through the TOF scheme, the distance and angle calculation between the tag and the master base station are performed by using the UWB scheme, to calculate the distance R₂ between the tag and the slave base station, and the angle θ₂ between the tag and the slave base station.

After the time difference between the tag and the slave base station through the TOF scheme is collected, the distance and angle calculation of the tag and the master base station are carried out through the UWB chip, and the distance is calculated as R₂ and the angle is θ₂.

Assuming that the antenna array from the base station includes two antennas and the antenna spacing is d₂, and the tag uses one antenna to receive the signal, the calculation formula of the difference ψ₂ between the signal phase from the first UWB antenna on the base station and the signal phase from the second UWB antenna is as follows:

$${Ψ}_{2} = ( 2 {πd}_{2} cos ( {θ}_{2} ) ) / λ \qquad ( 4 )$$

In formula (4), ψ₂ is the difference between the signal phase from the first UWB antenna on the slave base station and the signal phase from the second UWB antenna on the slave base station, λ is the signal wavelength, θ₂ is the angle between the tag and the slave base station, d₂ is the antenna spacing between the first UWB antenna on the slave base station and the second UWB antenna on the master base station, and π is the circular rate.

The angle θ₂ between the tag and the master base station is calculated by the following formula:

$${θ}_{2} = ar cos ( ( {ψ}_{2} λ ) / ( 2 π {d}_{2} ) ) \qquad ( 5 )$$

In formula (5), θ₂ is the angle between the tag and the slave base station, ψ₂ is the difference between the signal phase from the first UWB antenna on the slave base station and the signal phase from the second UWB antenna on the slave base station, λ is the signal wavelength, d₂ is the antenna spacing between the first UWB antenna on the slave base station and the second UWB antenna on the master base station, and π is the circular rate.

In step S600, it is defined that the center point of the master base station and the slave base station is the origin, and according to the distance R₁ between the tag and the master base station, and the distance R₂ between the tag and the slave base station, it is calculated that the possible position of the tag is the position point A or the position point B.

After the time difference between the tag and the slave base station through the TOF scheme is collected, the distance and angle calculation of the tag and the master base station are carried out through the UWB chip, and the distance is calculated as R₂ and the angle is θ₂. By defining the center point of the master and slave base station as the origin, the possible position of the tag is calculated by R₁ and R₂ as the position point A and the position point B.

In step S700, the position point A and the position point B are respectively judged through the preset first angle threshold and the second angle threshold, the error point is discarded, and the correct point is reserved; and the reserved right point is the position of the label at the current time, and the positioning of the master base station and the dual-base station from the base station is completed.

The position point A and the position point B are judged by the preset first angle threshold θ₁±3° and the second angle threshold θ₂±3°, the error point is discarded, and the correct point is reserved. The point is the precise position of the current time tag, and the TOF and angle judgment of the dual-base station are accurately located.

According to the UWB-based positioning tag positioning method provided by the embodiment, the method is applied to UWB-based positioning equipment, compared with the prior art, after the master base station is started, the master base station broadcasts self information to realize signal transmission and reception; after the master base station and the slave base station complete the Bluetooth connection, the master base station and the slave base station perform first time difference collection through the TOF scheme, and the UWB scheme is adopted to calculate the distance and the angle between the master base station and the slave base station; after the tag is started, the tag is changed to a discoverable state, the master base station establishes a connection with the tag after searching the tag, and the tag sends the MAC address of the master base station to the master base station; after the master base station performs data encryption on the MAC address of the tag, the encrypted data is transmitted and received to the tag and the slave base station, and communication connection between the master base station and the slave base station and the tag is realized through the encrypted MAC ID as a communication basis; after the second time difference is collected between the tag and the master base station through the TOF scheme, the distance and the angle between the tag and the master base station are calculated by adopting the UWB scheme, and the distance R₁ between the tag and the master base station, the angle θ₁ between the tag and the master base station is calculated; after the third time difference is collected through the TOF scheme between the tag and the slave base station, the distance and angle calculation of the tag and the master base station are carried out by adopting the UWB scheme, the distance R₂ between the tag and the slave base station is calculated, and the angle θ₂ between the tag and the slave base station is calculated; the center point of the master base station and the slave base station is defined as the origin, the distance R₁ between the tag and the master base station, and the distance R₂ between the tag and the slave base station are calculated, and the possible position of the tag is calculated to be the position point A or the position point B; the position point A and the position point B are judged through the preset first angle threshold and the second angle threshold, the error point is abandoned, and the correct point is reserved; and the reserved right point is the position of the tag at the current time, and the positioning of the master base station and the slave base station dual-base station is completed. According to the UWB-based dual-base station positioning tag positioning method provided by the embodiment, accurate positioning is achieved through the dual-base station, base station information communication connection and communication group establishment are carried out through Bluetooth, compared with three or more base stations, positioning and lowering cost is reduced, and compared with single base station positioning, the positioning precision is improved.

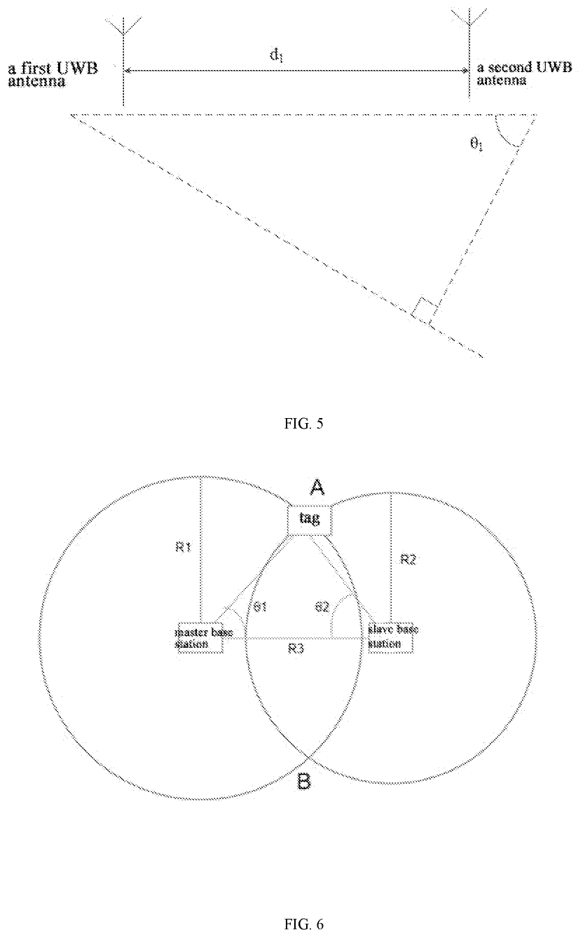

Further, referring to FIG. 3 and FIG. 6, FIG. 3 is a schematic flowchart of an embodiment of step S600 shown in FIG. 1.

In step S610, a circle is drawn by taking the distance R1 between the master base station as the circle center, the label and the master base station as the radius.

In step S620, a circle is drawn from the base station as a circle center, and a distance R2 between the label and the slave base station is a radius.

Step S630: defining a position point A above the intersection point of two circles, and a position point B below the intersection point; setting the master base station as a zero point, the direction of the slave base station being the X axis direction, the above slave base station being the Y axis positive direction, then the coordinates of the position point A and the position point B being ((R₃²+R₁²−R₂²)/2/R₃, ±((R₁²+R₂²)/2−R₃²/4−(R₁²−R₂²)²/4/R₃²)¹/2), if (θ₁+θ₂)<180°, the calculated point is the position point A ((R₃²+R₁²−R₂²)/2/R₃, ((R₁²+R₂²)/2−R₃²/4−(R₁²−R₂²)²/4/R₃²)¹/2); if (θ₁+θ₂)>180°, the calculated point is the position point B ((R₃²+R₁²−R₂²)/2/R₃, −((R₁²+R₂²)/2−R₃²/4−(R₁²−R₂²)²/4/R₃²)¹/2), where R₁ is the distance between the main base station and the tag, R₂ is the distance between the slave base station and the tag, R₃ is the distance between the master base station and the slave base station; θ₁ is the angle between the master base station and the tag, and θ₂ is the angle between the slave base station and the tag.

In the UWB-based positioning device, in the UWB-based positioning device, compared with the prior art, by taking the distance R₁ between the master base station as the circle center and the distance R₁ between the tag and the master base station as the radius circle; the distance R₂ from the base station as the circle center, the label and the slave base station is a radius circle; the coordinate of the position point A and the position point B is ((R₃²+R₁²−R₂²)/2/R₃, ±((R₁²+R₂²)/2−R₃²/4−(R₁²−R₂²)²/4/R₃²)¹/2), if (θ₁+θ₂)<180°, the calculated point is the position point A ((R₃²+R₁²−R₂²)/2/R₃, ((R₁²+R₂²)/2−R₃²/4−(R₁²−R₂²)²/4/R₃²)¹/2); if (θ₁+θ₂)>180°, the calculated point is the position point B ((R₃²+R₁²−R₂²)/2/R₃, −((R₁²+R₂²)/2−R₃²/4−(R₁²−R₂²)²/4/R₃²)¹/2), where R1 is the distance between the main base station and the tag, R₂ is the distance between the slave base station and the tag, R₃ is the distance between the master base station and the slave base station; θ₁ is the angle between the master base station and the tag, and θ₂ is the angle between the slave base station and the tag. According to the UWB-based dual-base station positioning tag positioning method provided by the embodiment, accurate positioning is achieved through the dual-base station, base station information communication connection and communication group establishment are carried out through Bluetooth, compared with three or more base stations, positioning and lowering cost is reduced, and compared with single base station positioning, the positioning precision is improved.

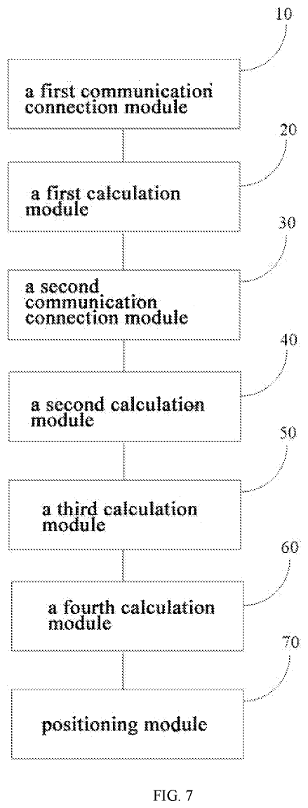

As shown in FIG. 7, FIG. 7 is a functional block diagram of an embodiment of a UWB-based dual-base station positioning tag according to an embodiment of the present disclosure, in this embodiment, a system for positioning a tag based on UWB dual-base station is applied to a UWB-based positioning device, the UWB-based positioning device includes a master base station 100, a slave base station 200, and a tag 300, the master base station 100, a slave base station 200, and a tag 300 establish a communication connection, and the UWB-based dual-base station positioning tag system includes a first communication connection module 10, a first calculation module 20, a second communication connection module 30, a second calculation module 40, a third calculation module 50, a fourth calculation module 60 and a positioning module 70, wherein the first communication connection module 10 is configured to broadcast its own information after the master base station is powered on, and implement signal transmission and reception; the first calculation module 20 is configured to: after the master base station and the slave base station complete the Bluetooth connection, perform first time difference collection between the master base station and the slave base station through the TOF scheme, and calculate a distance and an angle between the master base station and the slave base station by using the UWB scheme; a second communication connection module 30, configured to change itself to a discoverable state after the tag is powered on, and after the master base station searches for the tag, establishes a connection with the tag, and the tag sends the MAC address of the master base station to the master base station; the master base station performs data encryption on the MAC address of the tag, and transmits and receives the encrypted data to the tag and the slave base station, and implements communication connection between the master base station and the slave base station and the tag by using the encrypted MAC ID as a communication basis; a second calculation module 40, configured to calculate a distance and an angle between the tag and the master base station by using the UWB scheme after the second time difference is collected by using the TOF scheme, and calculate a distance R₁ between the tag and the master base station, and an angle θ₁ between the tag and the master base station; a third calculation module 50, configured to calculate a distance and an angle between the tag and the master base station by using the UWB scheme after the third time difference collection is performed between the tag and the slave base station through the TOF scheme, calculate a distance R₂ between the tag and the slave base station, and an angle θ₂ between the tag and the slave base station; a fourth calculation module 60, configured to define a center point of the master base station and the slave base station as an origin, and calculate, according to the distance R₁ between the tag and the master base station, and the distance R₂ between the tag and the slave base station, that the possible position of the tag is the position point A or the position point B; and a positioning module 70, configured to judge the position point A and the position point B respectively according to the preset first angle threshold and the second angle threshold, discard the error point, and reserve the correct point; and the reserved right point is the position of the tag at the current time, and complete the positioning of the master base station and the slave base station dual-base station.

The first communication connection module 10 is configured to supply power to the PCBA through an adapter or a built-in battery through the flash memory and the chip pre-storage software, and after being powered on, the master base station broadcasts its own information through the Bluetooth chip set inside the main base station, and realizes signal transmission and reception through the Bluetooth antenna arranged in the Bluetooth chip.

The first calculation module 20 is configured to: after the base station and the slave base station complete the Bluetooth connection, implement packet definition at the software layer by using the flash pre-stored software, control the PCBA release signal through the UWB chip, perform signal transmission and reception through the UWB antenna, perform time difference collection through the TOF scheme (TOF adopts a two-way ranging mode (DS-TWR), wherein the DS-TWR ranging principle is shown in FIG. 4), perform distance and angle calculation (distance calculation through the TOF scheme) between the master base station and the slave base station through the UWB chip (distance calculation is calculated through the TOF scheme, the angle calculation is calculated through an AOD (angle of departure method), the AOD calculation principle is as shown in FIG. 5 and description), and record and retain information through the chip and the flash memory.

Please refer to FIG. 4, DeviceA and DeviveB are the master base station and the slave base station. TX is transmit data and RX is receive data. The distance between the master base station and the slave base station is obtained by using the TOF distance measurement formula:

$${T}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )} \qquad ( 6 )$$

In formula (6), Tₚᵣₒₚ is the signal flight time, T_{round1} is the first communication cycle time, T_{reply1} is the first signal reply time, T_{round2} is the second communication cycle time, T_{reply2} is the second signal reply time, two round trip time measurements are used, and the two round trip time measurements are combined to obtain a time of flight result, and finally multiplied by the speed of light to obtain the real-time distance between the devices, which is Tₚᵣₒₚ*299792458 meters.

The second communication connection module 30 is used for the tag (actually located device, freely movable) to supply power to the PCBA through the built-in battery, and after being turned on, the tag is changed to the discoverable state through the Bluetooth chip, after the master base station searches for the tag, the tag is connected with the master base station through the Bluetooth chip, and the tag sends its own MAC address to the master base station. The master base station performs data encryption on the MAC address of the tag through the built-in function of the UWB chip, transmits data to and from the tag through the UWB chip, and uses the encrypted MAC ID (Media Access Control Identifier) as a communication basis to realize communication between the master base station and the slave base station and the tag.

The tag in the second calculation module 40 controls the PCBA release signal through the UWB chip, performs signal transmission and reception through the UWB antenna, and performs time difference collection through the TOF scheme. After the time difference between the tag and the master base station through the TOF scheme is collected, the distance and angle calculation of the tag and the master base station are carried out through the UWB chip, and the distance is calculated as R₁ and the angle is θ₁.

As shown in FIG. 5, assuming that the antenna array of the primary base station includes two antennas and the antenna spacing is d₁, and the label uses one antenna to receive the signal, the calculation formula of the difference ψ₁ between the signal phase from the first UWB antenna and the signal phase from the second UWB antenna on the master base station is as follows:

$${Ψ}_{1} = ( 2 π {d}_{1} cos ( {θ}_{1} ) ) / λ \qquad ( 7 )$$

In formula (7), ψ₁ is the difference between the signal phase of the first UWB antenna from the master base station and the signal phase of the second UWB antenna on the master base station, λ is the signal wavelength, θ₁ is the angle between the tag and the master base station, d₁ is the antenna spacing between the first UWB antenna on the master base station and the second UWB antenna on the master base station, and π is the circular rate.

The angle θ₁ between the tag and the master base station is calculated by the following formula:

$${θ}_{1} = ar cos ( ( {ψ}_{1} λ ) / ( 2 π {d}_{1} ) ) \qquad ( 8 )$$

In formula (8), θ₁ is the angle between the tag and the master base station, ψ₁ is the difference between the signal phase of the first UWB antenna from the master base station and the signal phase of the second UWB antenna on the master base station, λ is the signal wavelength, d₁ is the antenna spacing between the first UWB antenna on the master base station and the second UWB antenna on the master base station, and π is the circular rate.

After the third calculation module 50 defines the time difference between the tag and the slave base station through the TOF scheme, the distance and angle calculation of the tag and the master base station are performed by using the UWB chip, and the calculated distance is R₂, and the angle is θ₂.

Assuming that the antenna array from the base station includes two antennas and the antenna spacing is d₂, and the tag uses one antenna to receive the signal, the calculation formula of the difference ψ₂ between the signal phase from the first UWB antenna on the base station and the signal phase from the second UWB antenna is as follows:

$${Ψ}_{2} = ( 2 {πd}_{2} cos ( {θ}_{2} ) ) / λ \qquad ( 9 )$$

In formula (9), ψ₂ is the difference between the signal phase from the first UWB antenna on the slave base station and the signal phase from the second UWB antenna on the slave base station, λ is the signal wavelength, θ₂ is the angle between the tag and the slave base station, d₂ is the antenna spacing between the first UWB antenna on the slave base station and the second UWB antenna on the master base station, and π is the circular rate.

The angle θ₂ between the tag and the master base station is calculated by the following formula:

$${θ}_{2} = ar cos ( ( {ψ}_{2} λ ) / ( 2 π {d}_{2} ) ) \qquad ( 10 )$$

In formula (10), θ₂ is the angle between the tag and the slave base station, ψ₂ is the difference between the signal phase from the first UWB antenna on the slave base station and the signal phase from the second UWB antenna on the slave base station, λ is the signal wavelength, d₂ is the antenna spacing between the first UWB antenna on the slave base station and the second UWB antenna on the master base station, and π is the circular rate.

After the fourth calculation module 60 defines the time difference between the tag and the slave base station through the TOF scheme, the distance and angle calculation of the tag and the master base station are performed through the UWB chip, and the distance is calculated as R₂, and the angle is θ₂. By defining the center point of the master and slave base station as the origin, the possible position of the tag is calculated by R₁ and R₂ as the position point A and the position point B.

The positioning module 70 determines the position point A and the position point B by using a preset first angle threshold θ₁±3° and a second angle threshold θ₂±3°, discards the error point, and reserves a correct point. The point is the precise position of the current time tag, and the TOF and angle judgment of the dual-base station are accurately located.

In the UWB-based positioning device, in the UWB-based positioning device, compared with the prior art, the UWB-based dual-base station positioning tag system adopts the first communication connection module 10, the first calculation module 20, the second communication connection module 30, the second calculation module 40, the third calculation module 50, the fourth calculation module 60 and the positioning module 70, and broadcasts self information after the master base station is powered on to realize signal transmission and reception; after the master base station and the slave base station complete the Bluetooth connection, the master base station performs first time difference collection with the slave base station through the TOF scheme, and calculates the distance and the angle between the master base station and the slave base station by using the UWB scheme; after the tag is started, the master base station changes itself to a discoverable state, the master base station establishes a connection with the tag after searching the tag, and the tag sends the MAC address of the master base station to the master base station; the master base station performs data encryption on the MAC address of the tag, transmits the encrypted data to the tag and the slave base station, and implements communication connection between the master base station and the slave base station and the tag by using the encrypted MAC ID as the communication basis; after the second time difference is collected by using the TOF scheme between the tag and the master base station, the distance and the angle between the tag and the master base station are calculated by using the UWB scheme, and the distance R₁ between the tag and the master base station, and the angle θ₁ between the tag and the master base station are calculated; after the third time difference collection is performed between the tag and the slave base station through the TOF scheme, the distance and the angle calculation of the tag and the master base station are performed by adopting the UWB scheme, the distance R₂ between the tag and the slave base station, and the angle θ₂ between the tag and the slave base station are calculated; the center point of the master base station and the slave base station is defined as the origin, the distance R₁ between the tag and the master base station, and the distance R₂ between the tag and the slave base station are calculated, and the possible position of the tag is calculated to be the position point A or the position point B; the position point A and the position point B are judged according to the preset first angle threshold and the second angle threshold, the error point is discarded, and the correct point is reserved; and the reserved right point is the position of the tag at the current time, and the positioning of the master base station and the slave base station dual-base station is completed. According to the UWB-based dual-base station positioning tag system provided by the embodiment, accurate positioning is achieved through the dual-base station, base station information communication connection and communication group establishment are carried out through Bluetooth, compared with three or more base stations, positioning reduction cost is reduced, and positioning precision is improved compared with single base station positioning.

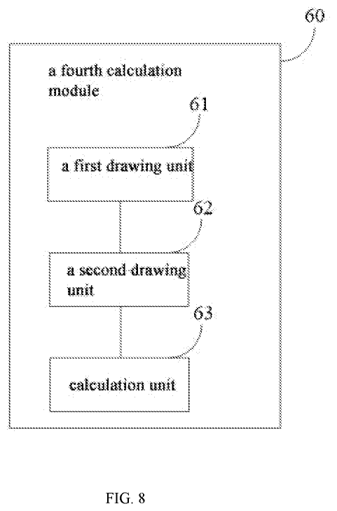

Referring to FIG. 8, FIG. 8 is a schematic diagram of functional modules of an embodiment of the positioning module shown in FIG. 7, in this embodiment, the fourth calculation module 60 includes a first drawing unit 61, a second drawing unit 62, and a calculating unit 63, wherein, please refer to FIG. 6, the first drawing unit 61 is configured to circle a circle with a distance R₁ between the main base station as a circle center and a distance R₁ between the label and the master base station; a second drawing unit 62 is configured to circle a circle with a radius from the base station as a circle center and a distance R₂ between the label and the slave base station; the calculating unit 63 is configured to define a position point A above the two circle intersection points, and a position point B below the intersection point; set the master base station as a zero point, and when the direction of the base station is the X axis direction and the above slave base station is a Y axis positive direction, coordinates of the position point A and the position point B are ((R₃²+R₁²−R₂²)/2/R₃, ±((R₁²+R₂²)/2−R₃²/4−(R₁²−R₂²)²/4/R₃²)¹/2), if (θ₁+θ₂)<180°, the calculated point is a position point A ((R₃²+R₁²−R₂²)/2/R₃, ((R₁²+R₂²)/2−R₃²/4−(R₁²−R₂²)²/4/R₃²)¹/2); if (θ₁+θ₂)>180°, the calculated point is a position point B ((R₃²+R₁²−R₂²)/2/R₃, −((R₁²+R₂²)/2−R₃²/4−(R₁²−R₂²)²/4/R₃²)¹/2), wherein R₁ is the distance between the main base station and the tag, R₂ is the distance between the slave base station and the tag, R₃ is the distance between the main base station and the slave base station, θ₁ is the angle between the main base station and the tag, and θ₂ is the angle between the slave base station and the tag.

In the UWB-based positioning device provided in this embodiment, compared with the prior art, the fourth calculation module 60 adopts the first drawing unit 61, the second drawing unit 62 and the calculating unit 63, and draws a circle by taking the distance R₁ between the main base station as the circle center and the distance R₁ between the label and the main base station as the radius; taking the distance R₂ from the base station as the circle center and the distance R₂ between the label and the slave base station as the radius drawing circle; defining the position point A above the two circle intersection points, and taking the position point B below the intersection point; setting the master base station as the zero point, and when the direction of the base station is the X axis direction and the above slave base station is the Y axis positive direction, the coordinates of the position point A and the position point B are ((R₃²+R₁²−R₂²)/2/R₃, ±((R₁²+R₂²)/2−R₃²/4−(R₁²−R₂²)²/4/R₃²)¹/2) if (θ₁+θ₂)<180°, the calculated point is the position point A (R₃²+R₁²−R₂²)/2/R₃, ((R₁²+R₂²)/2−R₃²/4−(R₁²−R₂²)²/4/R₃²)¹/2); if (θ₁+θ₂)>180°, the calculated point is the position point B ((R₃²+R₁²−R₂²)/2/R₃, −((R₁²+R₂²)/2−R₃²/4−(R₁²−R₂²)²/4/R₃²)¹/2) wherein R₁ is the distance between the main base station and the tag, R₂ is the distance between the slave base station and the tag, R₃ is the distance between the main base station and the slave base station, θ₁ is the angle between the main base station and the tag, and θ₂ is the angle between the slave base station and the tag. According to the UWB-based dual-base station positioning tag system provided by the embodiment, accurate positioning is achieved through the dual-base station, base station information communication connection and communication group establishment are carried out through Bluetooth, compared with three or more base stations, positioning reduction cost is reduced, and positioning precision is improved compared with single base station positioning.

Given the teachings of embodiments of the disclosure provided herein, one of ordinary skill in the art will be able to contemplate other implementations and applications of the techniques of embodiments of the disclosure.

Although illustrative embodiments of the disclosure have been described herein with reference to the accompanying drawings, it is to be understood that embodiments of the disclosure are not limited to those precise embodiments, and that various other changes and modifications are made therein by one skilled in the art without departing from the scope of the appended claims.

What is claimed is:

1. A method for positioning a tag by a Ultra-wideband (UWB) based dual-base station, applied to a UWB-based positioning device, the UWB-based positioning device comprising a master base station, a slave base station, and a tag, the master base station, the slave base station and the tag establishing a communication connection, the method comprising following steps:
broadcasting the master base station's information to realize signal transmission and reception, after the master base station is powered on;
completing Bluetooth connection between the master base station and the slave base station, the master base station and the slave base station performing a first time difference collection through a TOF scheme, and calculating a distance and angle between the master base station and the slave base station by using a UWB scheme;
changing to a discoverable state after the tag is turned on, the master base station establishing a connection with the tag after searching the tag, and the tag sending its own MAC address to the master base station; the master base station performs data encryption on the MAC address of the tag, transmitting the encrypted data to the tag and the slave base station, and implementing communication connection between the master base station and the slave base station and the tag by using the encrypted MAC ID as a communication basis;
collecting a second time difference between the tag and the master base station through the TOF scheme, calculating the distance and angle between the tag and the master base station by using the UWB scheme, and calculating a distance R₁ between the tag and the master base station and an angle θ₁ between the tag and the master base station;
collecting a third time difference between the tag and the master base station through the TOF scheme, calculating the distance and angle between the tag and the master base station by using the UWB scheme, and calculating a distance R₂ between the tag and the master base station and an angle θ₂ between the tag and the master base station;
defining a center point of the master base station and the slave base station as an origin, and calculating, according to the distance R₁ between the tag and the master base station, and the distance R₂ between the tag and the slave base station, that the possible position of the tag is a position point A or a position point B; and
judging the position point A and the position point B respectively through a preset first angle threshold and a second angle threshold, wherein the error point is discarded, and the correct point is reserved; the reserved correct point is the position of the label at the current time, and the positioning of the master base station and the slave base station dual-base station is completed.

2. The method according to claim 1, wherein collecting the second time difference between the tag and the master base station through the TOF scheme, the distance and the angle between the tag and the master base station are calculated by using the UWB scheme, the distance R₁ between the tag and the master base station, the angle θ₁ between the tag and the master base station is calculated, the distance R₁ between the tag and the master base station is calculated through the TOF scheme, and the angle θ₁ between the tag and the master base station is calculated through the AOD angle.

3. The method according to claim 2, wherein the angle θ₁ between the tag and the master base station is calculated by the following formula:
$${θ}_{1} = ar cos ( ( {ψ}_{1} λ ) / ( 2 π {d}_{1} ) )$$
wherein θ₁ is the angle between the tag and the master base station, ψ₁ is the difference between the signal phase of a first UWB antenna on the master base station and the signal phase of a second UWB antenna on the master base station, λ is the signal wavelength, d₁ is the antenna spacing between the first UWB antenna on the master base station and the second UWB antenna on the master base station, and π is the circular rate.

4. The method according to claim 1, wherein collecting the third time difference between the tag and the master base station through the TOF scheme, the distance and angle calculation between the tag and the master base station are performed by using the UWB scheme, the distance R₂ between the tag and the slave base station, and the angle θ₂ between the tag and the slave base station are calculated, the distance R₂ between the tag and the slave base station is calculated through the TOF scheme, and the angle θ₂ between the tag and the slave base station is calculated by the AOD angle.

5. The method according to claim 1, wherein defining a center point of the master base station and the slave base station as an origin, and calculating the possible position of the tag as the position point A or the position point B according to the distance R₁ between the tag and the master base station and the distance R₂ between the tag and the slave base station comprising:
taking the master base station as a circle center, and the distance R₁ between the tag and the master base station as a radius circle;
taking the slave base station as a circle center, and the distance R₂ between the tag and the slave base station as a radius circle;
defining the intersection point of two circles, the position point A is defined above the intersection point, and the position point B is below the intersection point; the master base station is set to be a zero point, the direction of the base station is the positive direction of the X axis and the positive direction of the Y axis is above the master and slave base station, the coordinates of the position point A and the position point B are ((R₃²+R₁²−R₂²)/2/R₃, ±((R₁²+R₂²)/2−R₃²/4−(R₁²−R₂²)²/4/R₃²)¹/2), and the calculated point is the position point A ((R₃²+R₁²−R₂²)/2/R₃, ((R₁²+R₂²)/2−R₃²/4−(R₁²−R₂²)²/4/R₃²)¹/2) on the condition (θ₁+θ₂)<180°, the calculated point is the position point B ((R₃²+R₁²−R₂²)/2/R₃, −((R₁²+R₂²)/2−R₃²/4−(R₁²−R₂²)²/4/R₃²)¹/2) on the condition (θ₁+θ₂)>180°, wherein R₁ is the distance between the main base station and the tag, R₂ is the distance between the slave base station and the tag, R₃ is the distance between the master base station and the slave base station; θ₁ is the angle between the master base station and the tag, and θ₂ is the angle between the slave base station and the tag.

6. A system for positioning a tag of a UWB-based dual-base station, applied to a UWB-based positioning device, wherein the UWB-based positioning device comprises a master base station, a slave base station, and a tag, the master base station, the slave base station and the tag establish a communication connection, and the UWB-based dual-base station positioning tag system comprising:
a first communication connection module, configured to broadcast its own information after the master base station is powered on to realize signal transmission and reception;
a first calculation module, configured to: after the master base station and the slave base station complete the Bluetooth connection, perform a first time difference collection between the master base station and the slave base station through a TOF scheme, and calculate a distance and an angle between the master base station and the slave base station by using a UWB scheme;
a second communication connection module, configured to, after the tag is turned on, change itself to a discoverable state, establish a connection with the tag after the master base station searches the tag, and send its own MAC address to the master base station; the master base station performs data encryption on the MAC address of the tag, transmits the encrypted data to the tag and the slave base station, and implements communication connection between the master base station and the slave base station and the tag by using the encrypted MAC ID as a communication basis;
a second calculation module, configured to calculate a distance and angle between the tag and the master base station by using the UWB scheme after a second time difference is collected by using the TOF scheme between the tag and the master base station, and calculate a distance R₁ between the tag and the master base station, and an angle θ₁ between the tag and the master base station;
a third calculation module, configured to perform a third time difference collection between the tag and the slave base station through the TOF scheme, perform distance and angle calculation of the tag and the master base station by using the UWB scheme, calculate a distance R₂ between the tag and the slave base station, and an angle θ₂ between the tag and the slave base station;
a fourth calculation module, configured to define that the center point of the master base station and the slave base station is the origin, and calculate, according to the distance R₁ between the tag and the master base station, and the distance R₂ between the tag and the slave base station, that the possible position of the tag is a position point A or a position point B; and
a positioning module, configured to determine, by using a preset first angle threshold and a second angle threshold, the position point A and the position point B respectively, discard an error point, and reserve a correct point; and if the reserved correct point is a position of the label at a current time, complete positioning of the master base station and the slave base station dual-base station.

7. The system according to claim 6, wherein in the second calculation module, the distance R₁ between the tag and the master base station is calculated through the TOF scheme, and the angle θ₁ between the tag and the master base station is calculated by the AOD angle.

8. The system according to claim 7, wherein the angle θ₁ between the tag and the master base station is calculated by the following formula:
$${θ}_{1} = ar cos ( ( {ψ}_{1} λ ) / ( 2 π {d}_{1} ) )$$
wherein θ₁ is the angle between the tag and the master base station, ψ₁ is the difference between the signal phase of the first UWB antenna on the master base station and the signal phase of the second UWB antenna on the master base station, λ is the signal wavelength, d₁ is the antenna spacing between the first UWB antenna on the master base station and the second UWB antenna on the master base station, and π is the circular rate.

9. The system according to claim 6, wherein in the third calculation module, the distance R₂ between the tag and the slave base station is calculated through the TOF scheme, and the angle θ₂ between the tag and the slave base station is calculated through the AOD angle.

10. The system according to claim 6, wherein the fourth calculation module comprises:
a first drawing unit, configured to circle a circle with the distance R₁ between the tag and the master base station as a circle center of the master base station;
a second drawing unit, configured to circle a circle with the distance R₂ between the label and the slave base station as a circle center; and
a calculation unit, configured to define a position point A above an intersection point of two circles, and a position point B below an intersection point; set a main base station as a zero point, and a direction of the base station from a base station direction to a positive direction of the X axis, and a positive direction of a Y axis above the master and slave base station, wherein coordinates of the position point A and the position point B are ((R₃²+R₁²−R₂²)/2/R₃, ±((R₁²+R₂²)/2−R₃²/4−(R₁²−R₂²)²/4/R₃²)¹/2), and the calculated point is a position point A ((R₃²+R₁²−R₂²)/2/R₃, ((R₁²+R₂²)/2−R₃²/4−(R₁²−R₂²)²/4/R₃²)¹/2) on the condition (θ₁+θ₂)<180°; the calculated point is a position point B ((R₃²+R₁²−R₂²)/2/R₃, −((R₁²+R₂²)/2−R₃²/4−(R₁²−R₂²)²/4/R₃²)¹/2) on the condition (θ₁+θ₂)>180°, wherein R₁ is the distance between the main base station and the tag, R₂ is the distance between the slave base station and the tag, R₃ is the distance between the master base station and the slave base station; θ₁ is the angle between the master base station and the tag, and θ₂ is the angle between the slave base station and the tag.
